(19) United States
(12) Patent Application Publication
(10) Pub. No.: US 2025/0106573 A1
(43) Pub. Date: Mar. 27, 2025

(54) LOUDSPEAKER SYSTEM IDENTIFICATION AND DYNAMIC UPDATING OF LOUDSPEAKER SYSTEM PARAMETERS

(71) Applicant: Meta Platforms Technologies, LLC, Menlo Park, CA (US)

(72) Inventor: Limin Zhou, Redmond, WA (US)

(21) Appl. No.: 17/967,880

(22) Filed: Oct. 17, 2022

Related U.S. Application Data
(60) Provisional application No. 63/292,983, filed on Dec. 22, 2021.

(51) Int. Cl. H04R 29/00; H04R 3/00; H04R 11/02

(52) U.S. Cl. CPC H04R 29/001; H04R 3/002; H04R 11/02

(57) ABSTRACT

An audio system comprises a loudspeaker configured to generate sound, and an audio controller for performing determining current value(s) of loudspeaker system parameter(s) and dynamic updating of loudspeaker system parameter(s). The audio controller is configured to calculate loudspeaker system parameter(s) according to a ratio of loudspeaker displacement to force applied to the loudspeaker and based on current and voltage measured across a loudspeaker. The loudspeaker system parameter(s) include a total mass parameter that relates to a moving mass of the loudspeaker and a radiation mass of a porting of the loudspeaker. The audio controller is configured to calculate an error as a difference between an expected signal and a measured signal based on the current and/or the voltage. The audio controller is configured to update the loudspeaker system parameter(s) based on the error. The audio controller is configured to deliver audio content via the loudspeaker with the updated loudspeaker system parameter(s).

### CROSS-REFERENCE TO RELATED APPLICATIONS

This application claims the benefit of U.S. Provisional Application No. 63/292,983, filed on Dec. 22, 2021, which is incorporated by reference in its entirety.

### FIELD OF THE INVENTION

This disclosure relates generally to artificial reality systems, and more specifically to determining and updating of loudspeaker system parameters in loudspeakers for artificial reality systems.

### BACKGROUND

Current conventional loudspeaker system identification algorithms for real-time applications assume that the total mass of the loudspeaker does not vary over time thus is held constant throughout the tuning algorithm. This limits the applicability of these conventional algorithms causing potential waste of energy from imprecise actuation of the loudspeaker or poor user experience in the generation of imprecise sound.

### SUMMARY

An audio system identifies loudspeaker linear parameters and updates the system linear parameters. Loudspeaker system identification generally refers to the process of determining loudspeaker system parameters based on electrical measurements across the loudspeaker. Loudspeaker linear parameters are characteristics of a loudspeaker that affect how the loudspeaker generates sounds. The loudspeaker system parameter(s) can include a total mass parameter that relates to a moving mass of the loudspeaker and a radiation mass of a porting of the loudspeaker. Each loudspeaker may be susceptible to variance in its loudspeaker system parameters. Audio systems that operate without loudspeaker system identification can cause waste of energy from imprecise actuation of the loudspeaker or poor user experience in the generation of imprecise sound.

The audio system comprises an audio controller configured to determine current values of the loudspeaker system parameter(s). The audio controller can determine the current values by calculating the loudspeaker system parameter(s) with one or more equations interrelating the loudspeaker system parameters. One such equation is based on a ratio of loudspeaker displacement to force applied to the loudspeaker. The audio controller is configured to calculate an error as a difference between an expected signal and a measured signal based on the current and/or the voltage. The audio controller is configured to update the loudspeaker system parameter(s) based on the calculated error. In one or more embodiments, the audio controller updates the loudspeaker system parameter(s) using a recursive function that applies a corrective step to the current value. The corrective step may be based on the calculated error and a convergence hyperparameter. With the updated loudspeaker system parameter(s), the audio controller is configured to deliver audio content via the loudspeaker.

The audio controller may further monitor loudspeaker health based on the loudspeaker system identification. The audio controller can periodically determine a loudspeaker health, compared against a baseline health, based on the current values of the loudspeaker system parameters. For example, if the stiffness of the loudspeaker has decreased significantly, then the audio controller may determine the loudspeaker health to have drastically declined from the baseline health. In other embodiments, the audio controller implements one or more health triggers. A health trigger may trigger when a loudspeaker system parameter falls outside an acceptable tolerance range of values. The audio controller may provide such notifications to a client device to notify a user of the monitored health. The notifications may further include remedial measures to address the loudspeaker health.

In one aspect, a computer-implemented method is disclosed for loudspeaker system identification and updating of loudspeaker system parameters. The method includes calculating one or more loudspeaker system parameters according to a ratio of loudspeaker displacement to force applied to the loudspeaker and based on current and voltage measured across a loudspeaker, wherein the loudspeaker system parameters include a total mass parameter that relates to a moving mass of the loudspeaker and a radiation mass of a porting of the loudspeaker. The method includes calculating an error as a difference between an expected signal and a measured signal based on the current and the voltage. The method includes updating one or more of the loudspeaker system parameters based on the error. The method includes delivering audio content via the loudspeaker with the updated one or more loudspeaker system parameters.

In another aspect, an audio system is disclosed capable of dynamically performing loudspeaker system identification and updating of loudspeaker system parameters. The audio system comprises a loudspeaker system and an audio controller. The loudspeaker has one or more loudspeaker system parameters, wherein the loudspeaker is configured to generate sound from an electrical signal. The audio controller is configured to: calculate one or more loudspeaker system parameters according to a ratio of loudspeaker displacement to force applied to the loudspeaker and based on current and voltage measured across a loudspeaker, wherein the loudspeaker system parameters include a total mass parameter that relates to a moving mass of the loudspeaker and a radiation mass of a porting of the loudspeaker; calculate an error as a difference between an expected signal and a measured signal based on the current and the voltage; update one or more of the loudspeaker system parameters based on the error; and deliver audio content via the loudspeaker with the updated one or more loudspeaker system parameters.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a HMD, in accordance with one or more embodiments.

FIG. 2 is a block diagram of an audio system, in accordance with one or more embodiments.

FIG. 3 is an overview flowchart illustrating a process for providing audio content while dynamically adjusting loudspeaker system parameters, in accordance with one or more embodiments.

FIG. 4 is a flowchart illustrating a process for loudspeaker system identification, in accordance with one or more embodiments.

FIG. 5 is a flowchart illustrating a method of delivering audio content relying on loudspeaker system identification and updating of loudspeaker system parameters, in accordance with one or more embodiments.

FIG. 6 is an example system environment of a headset including an audio system, in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### Overview

An audio system identifies loudspeaker linear parameters and updates the system linear parameters. Loudspeaker linear parameters are characteristics of a loudspeaker, which may include one or more electrical characteristics, one or more mechanical characteristics, or some combination thereof. The loudspeaker system parameters may include total mass, total stiffness, total mechanical resistance, another type of mechanical characteristic of the loudspeaker, electrical resistance, electrical inductance, force factor, another type of electrical characteristic, or some combination thereof. The total mass refers to the moving mass of the loudspeaker and radiation mass of the porting, wherein the moving mass refers to the mass of diaphragm and voice coil of the loudspeaker, wherein the diaphragm is oscillated to generate air pressure waves to produce sound. The total mass may be susceptible to variation (e.g., manufacturing tolerance), change based on environment (e.g., humidity or temperature may fluctuate mass) or change over time (e.g., with degradation or collecting particulates), or change when the loudspeaker porting is contaminated with dust which alters the radiation mass, providing a need to update the total mass. In one or more embodiments, the audio system updates a total mass in addition to other parameters of the loudspeaker. The audio system utilizes measured voltage and measured current of the loudspeaker in one or more equations to calculate the loudspeaker system parameters. With the calculated loudspeaker system parameters, the audio system updates the loudspeaker based on the calculated error. The audio system can deliver precise audio content via the updated loudspeaker.

Loudspeaker system identification and dynamic updating of loudspeaker system parameters is advantageous in precisely generating sound by the loudspeaker system as intended, increasing efficiency in sound generation and provision of high-fidelity sound. With increased efficiency in sound generation, the audio system can accurately anticipate energy usage in driving the loudspeakers. In addition, high-fidelity sound improves a user's experience of the delivered audio content. Moreover, real-time loudspeaker system identification creates an opportunity to monitor loudspeaker health, providing insight when maintenance or repairs are needed.

### Artificial Reality Implementations

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

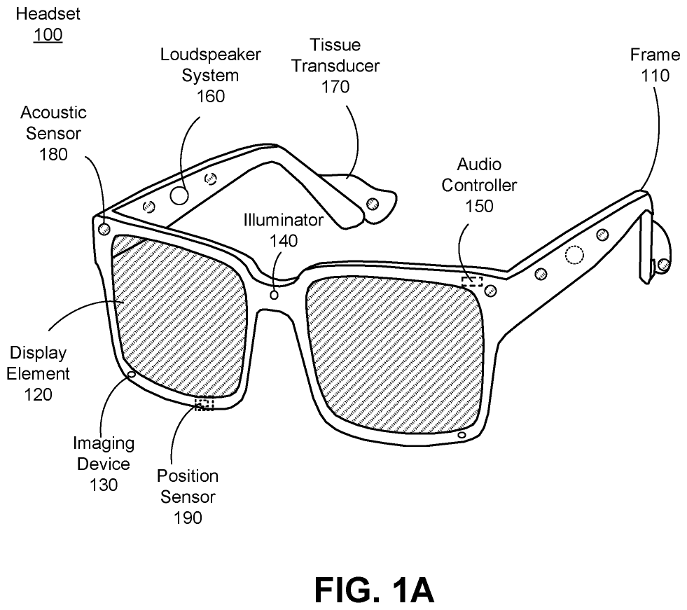

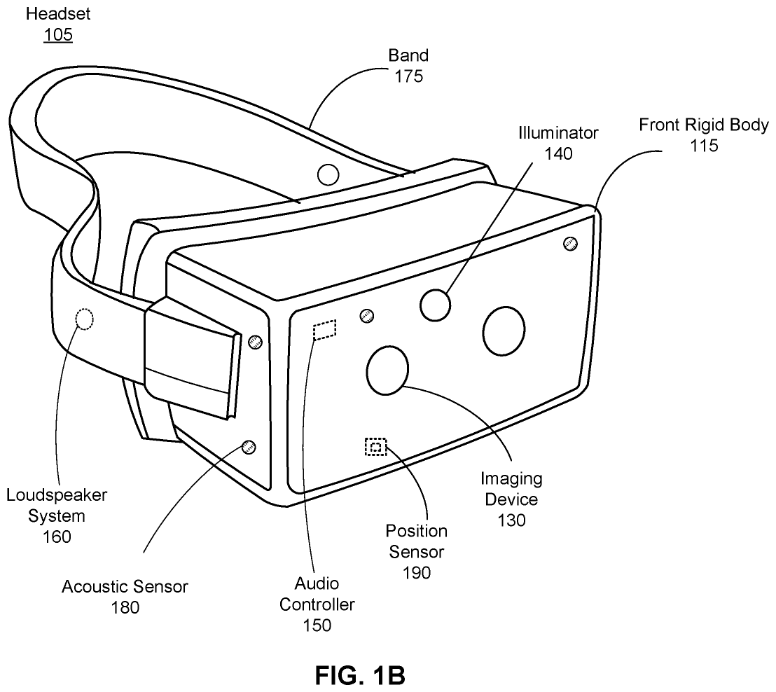

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a loudspeaker system 160 or a tissue transducer 170 (e.g., a bone conduction transducer or a cartilage conduction transducer). Although the loudspeaker systems 160 are shown exterior to the frame 110, the loudspeaker systems 160 may be enclosed in the frame 110. In some embodiments, instead of individual loudspeakers for each ear, the headset 100 includes a loudspeaker array comprising multiple loudspeaker systems integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

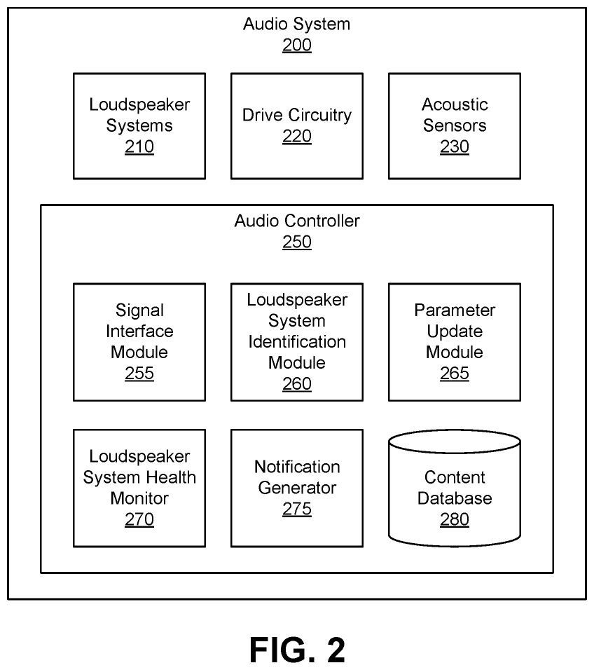

The audio controller 150 manages operation of other components of the audio system. In one or more embodiments, the audio controller 150 performs loudspeaker system identification and dynamic updating of loudspeaker system parameters. The audio controller 150 may adjust the loudspeaker system parameters to improve precision in sound generation by the loudspeaker systems 160. Further detail regarding loudspeaker system identification and dynamic updating of loudspeaker system parameters is described in conjunction with FIGS. 2-5. The audio controller 150 may also process information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the loudspeaker systems 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

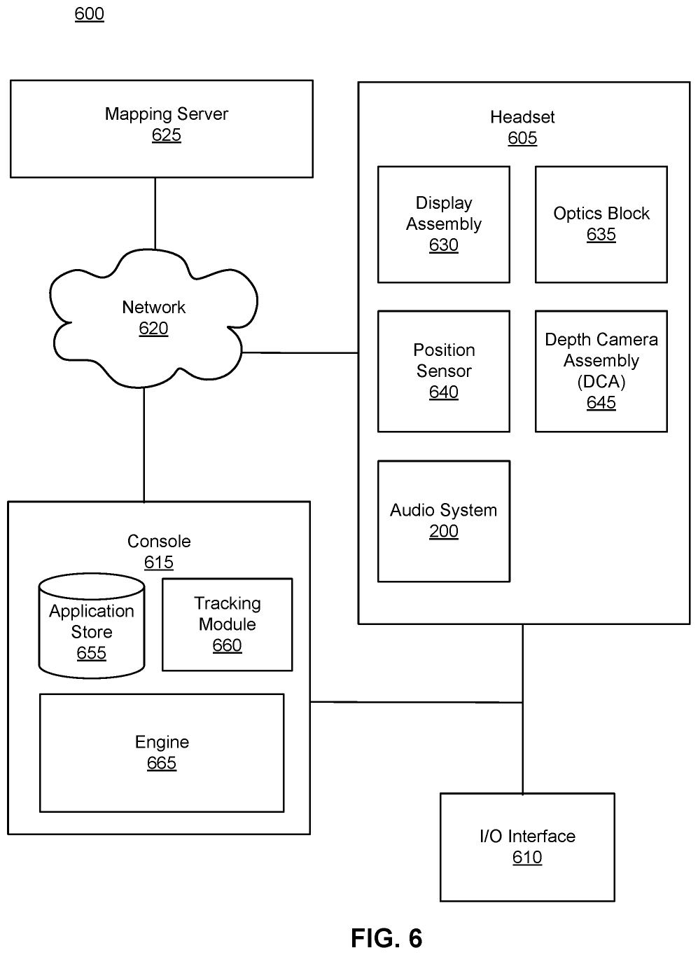

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the loudspeaker systems 160, a plurality of the imaging devices 130, a plurality of acoustic sensors 180, and the position sensor 190. The loudspeaker systems 160 may be located in various locations, such as coupled to the band 175 (as shown), coupled to front rigid body 115, or may be configured to be inserted within the ear canal of a user.

### Audio System Architecture

FIG. 2 is a block diagram of an audio system 200, in accordance with one or more embodiments. The audio system 200 includes mechanical and electrical components used to produce sound as part of audio content provided to a user. The audio system of FIG. 1 is an embodiment of the audio system 200. The audio system 200 comprises one or more loudspeaker systems 210, drive circuitry 220, and an audio controller 250. The audio system 200 may further comprise one or more acoustic sensors 230, one or more tissue transducers (not shown), or some combination thereof. In other embodiments, the audio system 200 may comprise additional components, fewer components, different components, or some combination thereof. In other embodiments, the various functions described as performable by the components may be variably distributed between the components.

The one or more loudspeaker systems 210 are mechanical transducers configured to generate sound through mechanical actuation. The loudspeaker systems 210 may be an embodiment of the loudspeaker systems 160 in FIG. 1. The loudspeaker systems 210 convert electrical signals from the drive circuitry 220 to create mechanical actuation of a diaphragm using a voice coil. Each loudspeaker system 210 may include a port that directs the generated sound out into an environment. Each loudspeaker system 210 includes one or more loudspeaker system parameters that are mechanical and electrical characteristics of the loudspeaker. The loudspeaker system parameters may include linear and non-linear parameters. The loudspeaker system parameters for a given loudspeaker system 210 may include total mass, total stiffness, total mechanical resistance, another type of mechanical characteristic of the loudspeaker, electrical resistance, electrical inductance, force factor, another type of electrical characteristic, or some combination thereof. The total mass refers to the moving mass of the loudspeaker and radiation mass of the porting, wherein the moving mass refers to the mass of diaphragm and voice coil of the loudspeaker, wherein the diaphragm is oscillated to generate air pressure waves to produce sound. The total mass may be susceptible to variation (e.g., manufacturing tolerance), change based on environment (e.g., humidity or temperature may fluctuate mass) or change over time (e.g., with degradation or collecting particulates), or change when the loudspeaker porting is contaminated with dust which alters the radiation mass, providing a need to update the total mass.

The drive circuitry 220 is an electrical circuitry that provides an electrical signal to a loudspeaker system 210 to generate sound. The drive circuitry 220 includes electrical components for delivering the electrical signal to drive the loudspeaker systems 210. The drive circuitry 220 also includes one or more electrical components for measuring electrical characteristics across the loudspeaker system 210 as sensed signals. The electrical characteristics measurable by the drive circuitry 220 includes, but is not limited to, current and voltage across the loudspeaker system 210. The drive circuitry 220 may provide the measurements to the audio controller 250. In one or more embodiments, the drive circuitry 220 includes separate circuitry for each loudspeaker system 210. In embodiments with tissue transducer 240, the drive circuitry 220 may also provide electrical signals to the tissue transducers 240 to generate sound.

The acoustic sensors 230 measure sound from an environment of the audio system 200. Each acoustic sensor 230 may be an embodiment of the acoustic sensors 180 in FIG. 1. Each acoustic sensor 230 is configured to detect sound and convert the detected sound into an electronic format (analog or digital), i.e., detected sound signals. The acoustic sensors 230 may be acoustic wave sensors, microphones, sound transducers, or similar sensors that are suitable for detecting sounds. The acoustic sensors 230 may provide the detected sound signals to the audio controller 250 for processing.

The audio controller 250 controls operation of the audio system 200. The audio controller 250 may be a general computing device comprising one or more processors and storage medium storing instruction for causing the processor to perform one or more operations. The audio controller 250 is an embodiment of the audio controller 150 of FIG. 1. The audio controller 250 comprises a signal interface module 255, a loudspeaker system identification module 260, a parameter update module 265, a loudspeaker system health monitor 270, a notification generator 275, and a content database 280. In other embodiments, the audio controller 250 may comprise additional modules/databases, fewer modules/databases, different modules/databases, or some combination thereof. In other embodiments, the various functions described as performable by the modules may be variably distributed between the modules.

The signal interface module 255 manages signals between the audio controller 250 and the other components of the audio system 200. The signal interface module 255 generates electrical signals for actuating the loudspeaker systems 210 and the tissue transducers 240. The signal interface module 255 may retrieve audio content from the content database 280 and generate the electrical signals for the loudspeaker systems 210 based on loudspeaker system parameters and for the tissue transducers 240 based on parameters of the tissue transducers. The signal interface module 255 may also receive sensed signals from the drive circuitry 220 including measurements of electrical characteristics measured across the loudspeaker systems 210. The signal interface module 255 may also receive the detected sound signals from the acoustic sensors 230. The signal interface module 255 may generate the electrical signals for actuating the loudspeaker systems 210 and the tissue transducers further based on the detected sound signals. For example, the signal interface module 255 may increase a volume in the electrical signals based on detecting lots of ambient noise in the environment from the detected sound signals.

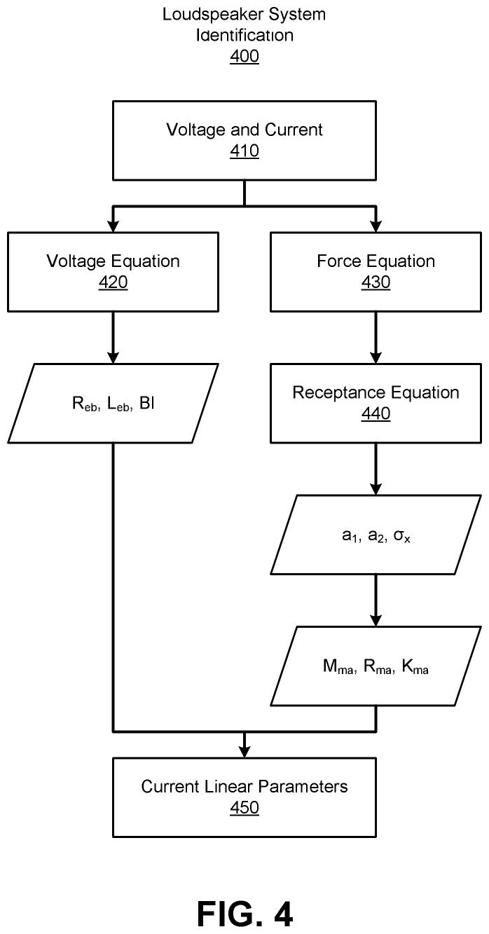

The loudspeaker system identification module 260 determines one or more loudspeaker system parameters based on the sensed signals from the drive circuitry 220. The loudspeaker system identification module 260 utilizes one or more equations interrelating one or more of the loudspeaker system parameters, including a total mass of the loudspeaker. The loudspeaker system identification module 260 calculates the loudspeaker system parameters from the one or more equations. In one or more embodiments, a first equation is based on the measured voltage across the loudspeaker system 210 including blocked electric resistance, blocked electric inductance, and force factor as loudspeaker system parameters. In one or more embodiments, a second equation is based on a ratio of displacement over force and includes infinite impulse response (IIR) filter coefficients as loudspeaker system parameters. In one or more embodiments, a third equation is based on loudspeaker system resonance frequency and includes the infinite impulse response filter coefficients, loudspeaker stiffness, moving mass as loudspeaker system parameters. In one or more embodiments, a fourth equation interrelates the IIR filter coefficients, the loudspeaker stiffness, moving mass, radiation mass, and frequency. The loudspeaker system identification module 260 can fix one or more loudspeaker system parameters, assuming no variation. The loudspeaker system identification module 260 determines a plurality of loudspeaker system parameters based on the one or more equations. FIG. 4 below further details loudspeaker system identification, in accordance with one or more embodiments.

The parameter update module 265 updates one or more of the loudspeaker system parameters. The parameter update module 265 calculates an error between an expected signal and a measured signal. The parameter update module 265 may determine the measured signal based on the current and the voltage measured across the loudspeaker system 210. The parameter update module 265 updates one or more of the loudspeaker system parameters based on the calculated error. The parameter update module 265 may further adjust one or more quality factors based on the parameters, one or more other characteristics of the loudspeaker, or some combination thereof. The parameter update module 265 may provide the tuned parameter, quality factors, characteristics, or some combination thereof to the signal interface module 255 to generate the electrical signals for generating the sound. As an example of a quality factor, the parameter update module 265 tunes the compliance of the loudspeaker which is a reciprocal of the stiffness. The parameter update module 265 provides updates loudspeaker system parameters to the signal interface module 255 to generate the electrical signals.

In one or more embodiments, the parameter update module 265 adjusts the determine loudspeaker system parameters according to a recursive function. The recursive function calculates the updated value of a loudspeaker system parameter based on the current value of the loudspeaker system parameter with a corrective step that is based on the calculated error (and may further be based on a convergence hyperparameter). The convergence hyperparameter determines large the corrective step is.

The parameter update module 265 may routinely update one or more of the loudspeaker system parameters. For example, the parameter update module 265 may update every ten seconds or so. In other examples, the periodicity may be longer, e.g., updating every couple of weeks or another period on the order of weeks/months. On any given update iteration, the parameter update module 265 may choose to update a subset of the loudspeaker system parameters. For example, only updating the moving mass loudspeaker system parameter.

The loudspeaker system health monitor 270 monitors health of the loudspeaker based on the loudspeaker system parameters determined by the loudspeaker system identification module 260. The loudspeaker system health monitor 270 may include one or more health triggers. The health triggers have one or more triggering conditions that, when triggered, indicate a loudspeaker health issue. The triggering condition can define a tolerance range of values for a loudspeaker system parameter. When a loudspeaker system parameter is outside the tolerance range, the triggering condition is satisfied. For example, if the total mass exceeds a certain threshold, the loudspeaker system health monitor 270 determines there to a loudspeaker health issue, e.g., blockage of the loudspeaker port. In some embodiments, the loudspeaker system health monitor 270 may determine a loudspeaker health based on the loudspeaker system parameters. For example, the loudspeaker system health monitor 270 may determine the loudspeaker system parameters after assembly of the loudspeaker system 210, which is used to set a baseline loudspeaker health. As the audio controller 250 iteratively performs loudspeaker system identification and parameter updating, the loudspeaker system health monitor 270 may determine an updated loudspeaker health compared against the baseline loudspeaker health, e.g., loudspeakers are operating at 75% efficiency of manufacturer's specifications. The loudspeaker system health monitor 270 may provide the loudspeaker health issues and/or the loudspeaker health to the notification generator 275.

The notification generator 275 generates one or more notifications based on the loudspeaker system parameters, the loudspeaker health, any loudspeaker health issues, or some combination thereof. The notifications may be provided to a client device of a user. In some embodiments, the notification generator 275 may provide a notification indicating loudspeaker system parameters as identified by the loudspeaker system identification module 260. For example, a quality control engineer may be interested in such notifications to determine whether a particular loudspeaker is within manufacturing tolerance. In some embodiments, the notification generator 275 may provide a notification indicating a loudspeaker health. This notification may be provided in response to a request from a user of the audio system 200. In some embodiments, the notification generator 275 may provide a notification indicating a loudspeaker health issue and may further include one or more remedial measures to address the loudspeaker health issue. A remedial measure is an interventive action to improve loudspeaker health generally, or to resolve a particular loudspeaker health issue. For example, the loudspeaker's stiffness is below a threshold and a remedial measure recommending maintenance. As another example, the total mass may be above a threshold indicating a clogged port. The notification may indicate there is a potential clogged port and the remedial measure recommending cleaning of the port. Other example remedial measures include a recommendation to replace a part, a recommendation to see a care specialist, recommendation to perform some other fix, etc.

The content database 280 stores audio content that may be provided to a user of the audio system 200. In one or more embodiments, the audio content includes sounds to be generated by the audio system 200, e.g., via the loudspeaker systems 210 and/or the tissue transducers 240. The signal interface module 255 may generate the electrical signals for actuating the loudspeakers and/or the tissue transducers based on the audio content. The content database 280 may obtain audio content from an external system via a network, e.g., streaming music from a music-sharing platform.

The user may opt-in to allow the content database 280 to record data captured by the audio system 200. In some embodiments, the audio system 200 may employ always on recording, in which the audio system 200 records all sounds captured by the audio system 200 in order to improve the experience for the user. The user may opt in or opt out to allow or prevent the audio system 200 from recording, storing, or transmitting the recorded data to other entities.

### Loudspeaker System Identification & Parameter Update

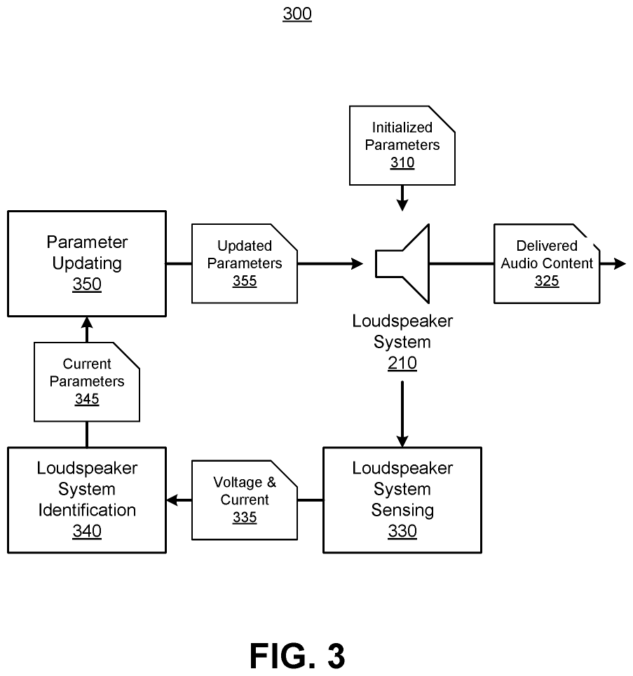

FIG. 3 is an overview flowchart illustrating a process 300 for providing audio content while dynamically adjusting loudspeaker system parameters, in accordance with one or more embodiments. The loudspeaker system identification and parameter updating is performed by the audio system 200 for the loudspeaker system 210. In other embodiments, the flowchart 300 includes additional, fewer, or different steps than shown in FIG. 3.

The audio system 200 may begin with initialized parameters 310. The initialized parameters may be values for the loudspeaker system parameters as set by a manufacturer of the loudspeaker system 210. The audio system 200 may generate electrical signals based on the initialized parameters, that actuate the loudspeaker system 210 to generate sound to deliver audio content 325.

The audio system 200 may perform loudspeaker system sensing 330 to measure electrical signals across the loudspeaker system 210 during generation of the sound. The driving circuit 220 may measure the electrical signals, including current and voltage 335.

The audio system 200 proceeds with loudspeaker system identification 340 to determine the current parameters 345 for the loudspeaker system 210. The audio system 200 may utilize one or more equations interrelating two or more of the loudspeaker system parameters. The audio system 200 utilizes the equations to calculate one or more of the loudspeaker system parameters using the voltage and current 335. FIG. 4 below further details loudspeaker system identification, in accordance with one or more embodiments.

The audio system 200 performs parameter updating 350 based on the current parameters 345. The audio system 200 may calculate an error as a difference between an expected signal and a measured signal based on the voltage and current 335. The audio system 200 utilizes the error to update one or more of the loudspeaker system parameters. In one or more embodiments, the audio system 200 updates parameters with a recursive function based on the current value of a loudspeaker system parameter and a corrective step based on the error. The corrective step may be further based on a convergence hyperparameter. The audio system 200 may further adjust one or more quality factors based on the parameters, one or more other characteristics of the loudspeaker, or some combination thereof. In one or more embodiments, the audio system 200 may determine and update a subset of loudspeaker system parameters while fixing a remainder of loudspeaker system parameters.

The audio system 200 may iteratively perform cycles of loudspeaker system identification and parameter updating to minimize the error between the expected signal the measured signal. In effect, the audio system 200 can more precisely generate sound as intended, saving energy from overdriven loudspeakers and improving user experience with high fidelity sound. For example, if a total mass of a loudspeaker system 210 has never been updated, and is significantly larger than the initial value, then the audio system 200 may be applying too little energy to drive the loudspeaker system 210 creating poor user experience from decreased output. Or, for example, the total mass of a loudspeaker system 210 is lower than what the audio system 200 anticipates the total mass to be, such that the audio system 200 is overdriving the loudspeaker system 210, thereby wasting energy and potentially applying an excessive force to the loudspeaker system 210.

The improved system identification algorithm is more widely applicable with the capability of updating the total mass parameter in addition to the other parameters. The tuning is also more robust given the added parameter. By updating the total mass, the audio system can determine whether the porting has been clogged with dust which degrades the audio performance. Upon determining that the porting is clogged, the audio system can generate and provide a notification to the user to clean the porting. In addition, as the total mass determines the loudspeaker system sensitivity, updating the total mass provides a more accurate power prediction for battery powered devices.

FIG. 4 is a flowchart 400 illustrating a process for determining loudspeaker linear parameters, in accordance with one or more embodiments. The flowchart 400 is performable by the audio controller 250, or more specifically the loudspeaker system identification module 260 of the audio controller 250 using the voltage and current 410 measured across the loudspeaker system 210. The audio controller 250 determines a plurality of loudspeaker system parameters by utilizing one or more equations to calculate the plurality of loudspeaker system parameters. In the embodiment shown, the audio controller 250 determines six loudspeaker system parameters R_{eb}, L_{eb}, Bl, Mₘₐ, Rₘₐ, and Kₘₐ.

The audio controller 250 utilizes a voltage equation 420 to determine R_{eb}, L_{eb}, and Bl. R_{eb} refers to electrical resistance of the loudspeaker. L_{eb} refers to electrical inductance of the loudspeaker. Bl refers to the force factor of the loudspeaker. The voltage equation relied upon is:

$${v}_{c} ( t ) = {R}_{e b} i ( t ) + {L}_{e b} \frac{d i ( t )}{d t} + B l \frac{d x ( t )}{d t} \qquad ( 1 )$$

v_{c} refers to the voltage driving the loudspeaker system 210; i(t) refers to the measured current; and x(t) refers to displacement of the diaphragm. With the above equation, the audio controller 250 can determine R_{eb}, L_{eb}, and Bl. The audio controller 250 may iteratively sample the loudspeaker system's measured signal. With the plurality of samples of the loudspeaker system's measured signal, the audio controller 250 may fit the samples, e.g., by performing least mean square to find the best fit for the samples. Example sampling frequency may be 48 kHz yielding a potential of 48,000 samples per second.

The audio controller 250 utilizes a force equation 430 to determine Mₘₐ, Rₘₐ, and Kₘₐ. Mₘₐ refers to total mass of the loudspeaker system; Rₘₐ refers to mechanical resistance of the loudspeaker system; and Kₘₐ refers to the stiffness of the loudspeaker system. The audio controller 250 starts with the force equation as:

$${f}_{c} ( t ) = {M}_{m a} \frac{{d}^{2} x ( t )}{d {t}^{2}} + {R}_{m a} \frac{d x ( t )}{d t} + {K}_{m a} x ( t ) \qquad ( 2 )$$

In the force equation, f_{c} refers to the force acting on the loudspeaker system 210.

The audio controller 250 also utilizes a receptance equation 440 to calculate IIR filter coefficients as intermediaries to calculating the Mₘₐ, Rₘₐ, and Kₘₐ. The receptance equation leverages a ratio of displacement to force, which may be expressed in terms of IR filter coefficients (a₁, a₂, and σₓ) as:

$$\frac{x [ z ]}{{f}_{c} [ z ]} = \frac{{σ}_{x} {z}^{- 1}}{1 + {a}_{1} {z}^{- 1} + {a}_{2} {z}^{- 2}} \qquad ( 3 )$$

Operating on this model lessens dependence between σₓ and the other coefficients a₁ and a₂. The variable z represents the z-domain, which encompasses discrete time signals (also referred to as sampled time signals). With these IIR filter coefficients, the audio controller can determine Mₘₐ (total mass) in addition to Rₘₐ (total mechanical resistance) and Kₘₐ (total stiffness). In one or more embodiments, the least mean square (LMS) method is used to iteratively update the parameters. The coefficient σₓ can be further represented in terms of the other coefficients a₁ and a₂ and Kₘₐ:

$${σ}_{x} = \frac{1 + {a}_{1} + {a}_{2}}{{K}_{m a}} \qquad ( 4 )$$

This audio controller 250 can calculate Kₘₐ knowing a₁, a₂, and σₓ. Now armed with a₁, a₂, σₓ, and Kₘₐ the audio controller 250 can calculate Mₘₐ and Rₘₐ using a loudspeaker system resonance frequency equation and a loudspeaker system damping ratio equation. The loudspeaker system resonance frequency equation may be as follows:

$${ω}_{0} = \sqrt{\frac{{K}_{m a}}{{M}_{m a}}} = \sqrt{{( ln \sqrt{{a}_{2}} )}^{2} + {tan}^{- 2} ( \frac{\sqrt{4 {a}_{2} - {a}_{1}^{2}}}{- {a}_{1}} )} \qquad ( 5 )$$

The audio controller 250 can calculate Mₘₐ with the above loudspeaker system resonance frequency equation. The loudspeaker system resonance damping ratio equation can be represented as:

$$ζ = \frac{{R}_{m a}}{2 \sqrt{{M}_{m a} {K}_{m a}}} = - \frac{{F}_{s} ln \sqrt{{a}_{2}}}{{ω}_{0}} \qquad ( 6 )$$

The audio controller 250 thereafter calculates Rₘₐ.

Upon finishing the calculations, the audio controller 250 has determined the current loudspeaker linear parameters: R_{eb}, L_{eb}, Bl, Mₘₐ, Rₘₐ, and Kₘₐ.

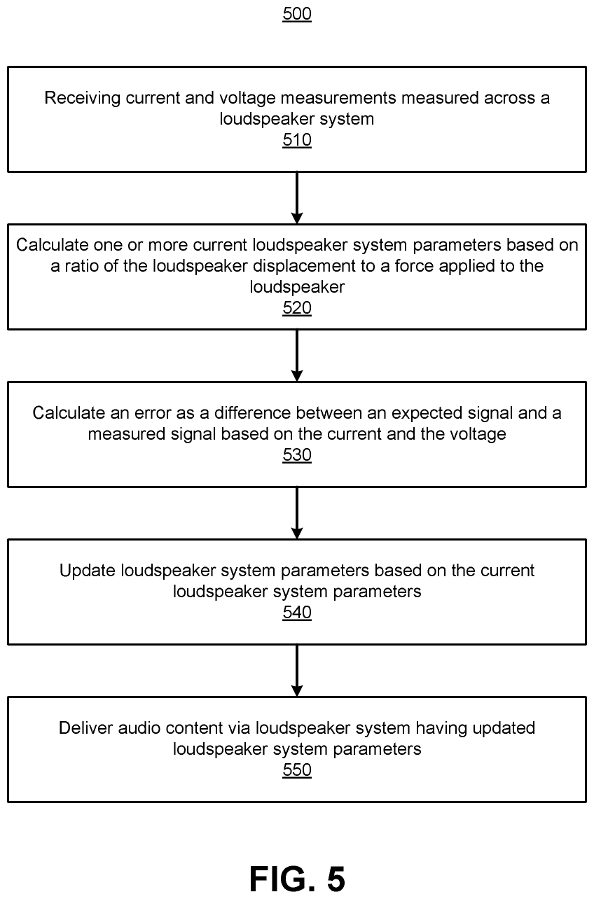

FIG. 5 is a flowchart illustrating the method 500 of delivering audio content relying on loudspeaker system identification and updating of loudspeaker system parameters, in accordance with one or more embodiments. Although the method 500 is described in the perspective of the audio controller 250, it can be understood that the audio system 200 can also perform the method 500. Moreover, it can be understood that, for each step of the method 500, one or more of the components of the audio system 200 may perform that step. In other embodiments, the method 500 may include additional steps, fewer steps, different steps, or some combination thereof.

The audio controller 250 receives 510 current and voltage measurements measured across a loudspeaker. The audio controller 250 may measure the current and voltage with one or more electrical components as part of the drive circuitry 220.

The audio controller 250 calculates 520 one or more current loudspeaker system parameters based on a ratio of the loudspeaker displacement to a force applied to the loudspeaker. The ratio may be the ratio reflected in the receptance equation (3) described under FIG. 4. The audio controller 250 may utilize additional equations, such as the voltage equation (1), the loudspeaker system resonance frequency equation (4) and the loudspeaker system resonance damping ratio equation (5).

The audio controller 250 calculates 530 an error as a difference between an expected signal and a measured signal based on the current and the voltage. The expected signal may be based on current values of the loudspeaker system parameters. The measured signal may be based on the current and the voltage. The error informs the imprecision of the current values of the loudspeaker system parameters.

The audio controller 250 updates 540 the loudspeaker system parameters based on the current loudspeaker system parameters. The audio controller 250 may update the loudspeaker system parameters the moving mass loudspeaker system parameter and the radiation mass loudspeaker system parameter. The audio controller 250 may utilize a recursive function that updates the loudspeaker system parameters based on the current value of the loudspeaker system parameter with a corrective step added. The audio controller 250 may also update one or more quality factors, one or more characteristics, or some combination thereof.

The audio controller 250 delivers 550 audio content via the loudspeaker having updated loudspeaker system parameters. The audio controller 250 can generate electrical signals to drive the loudspeaker based on the updated loudspeaker system parameters. Loudspeaker system identification and parameter updating is advantageous in delivering precise audio content.

### Example System Environment

FIG. 6 is a system 600 that includes a headset 605, in accordance with one or more embodiments. In some embodiments, the headset 605 may be the headset 100 of FIG. 1A or the headset 105 of FIG. 1B. The system 600 may operate in an artificial reality environment (e.g., a virtual reality environment, an augmented reality environment, a mixed reality environment, or some combination thereof). The system 600 shown by FIG. 6 includes the headset 605, an input/output (I/O) interface 610 that is coupled to a console 615, the network 620, and the mapping server 625. While FIG. 6 shows an example system 600 including one headset 605 and one I/O interface 610, in other embodiments any number of these components may be included in the system 600. For example, there may be multiple headsets each having an associated I/O interface 610, with each headset and I/O interface 610 communicating with the console 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 615 may be provided by the headset 605.

The headset 605 includes the display assembly 630, an optics block 635, one or more position sensors 640, and the DCA 645. Some embodiments of headset 605 have different components than those described in conjunction with FIG. 6. Additionally, the functionality provided by various components described in conjunction with FIG. 6 may be differently distributed among the components of the headset 605 in other embodiments, or be captured in separate assemblies remote from the headset 605.

The display assembly 630 displays content to the user in accordance with data received from the console 615. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUs, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The audio system 200 comprises a transducer array for delivering audio content to a user of the headset 605. The transducer array includes at least one loudspeaker. In some embodiments, the transducer array further comprises tissue transducers. The audio system 200 performs loudspeaker system identification to determine one or more current loudspeaker system parameters based on current and voltage measured across the loudspeaker. The audio system 200 also perform parameter updating to update the loudspeaker system parameters based on an error calculated as a difference between an expected signal and a measured signal. The audio system 200 may iteratively perform loudspeaker system identification and parameter updating to ensure the loudspeaker system 210 is performing precisely, thereby optimizing energy spent driving the loudspeaker and improving user experience of audio content.

The I/O interface 610 is a device that allows a user to send action requests and receive responses from the console 615. An action request is a request to perform a particular action. For example, an action request may be an instruction to start or end capture of image or video data, or an instruction to perform a particular action within an application. The I/O interface 610 may include one or more input devices. Example input devices include: a keyboard, a mouse, a game controller, or any other suitable device for receiving action requests and communicating the action requests to the console 615. An action request received by the I/O interface 610 is communicated to the console 615, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console 615. For example, haptic feedback is provided when an action request is received, or the console 615 communicates instructions to the I/O interface 610 causing the I/O interface 610 to generate haptic feedback when the console 615 performs an action.

The console 615 provides content to the headset 605 for processing in accordance with information received from one or more of: the DCA 645, the headset 605, and the I/O interface 610. In the example shown in FIG. 6, the console 615 includes an application store 655, a tracking module 660, and an engine 665. Some embodiments of the console 615 have different modules or components than those described in conjunction with FIG. 6. Similarly, the functions further described below may be distributed among components of the console 615 in a different manner than described in conjunction with FIG. 6. In some embodiments, the functionality discussed herein with respect to the console 615 may be implemented in the headset 605, or a remote system.

The application store 655 stores one or more applications for execution by the console 615. An application is a group of instructions, that when executed by a processor, generates content for presentation to the user. Content generated by an application may be in response to inputs received from the user via movement of the headset 605 or the I/O interface 610. Examples of applications include: gaming applications, conferencing applications, video playback applications, or other suitable applications.

The tracking module 660 tracks movements of the headset 605 or of the I/O interface 610 using information from the DCA 645, the one or more position sensors 640, or some combination thereof. For example, the tracking module 660 determines a position of a reference point of the headset 605 in a mapping of a local area based on information from the headset 605. The tracking module 660 may also determine positions of an object or virtual object. Additionally, in some embodiments, the tracking module 660 may use portions of data indicating a position of the headset 605 from the position sensor 640 as well as representations of the local area from the DCA 645 to predict a future location of the headset 605. The tracking module 660 provides the estimated or predicted future position of the headset 605 or the I/O interface 610 to the engine 665.

The engine 665 executes applications and receives position information, acceleration information, velocity information, predicted future positions, or some combination thereof, of the headset 605 from the tracking module 660. Based on the received information, the engine 665 determines content to provide to the headset 605 for presentation to the user. For example, if the received information indicates that the user has looked to the left, the engine 665 generates content for the headset 605 that mirrors the user's movement in a virtual local area or in a local area augmenting the local area with additional content. Additionally, the engine 665 performs an action within an application executing on the console 615 in response to an action request received from the I/O interface 610 and provides feedback to the user that the action was performed. The provided feedback may be visual or audible feedback via the headset 605 or haptic feedback via the I/O interface 610.

The network 620 couples the headset 605 and/or the console 615 to the mapping server 625. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 625 may include a database that stores a virtual model describing a plurality of spaces, wherein one location in the virtual model corresponds to a current configuration of a local area of the headset 605. The mapping server 625 receives, from the headset 605 via the network 620, information describing at least a portion of the local area and/or location information for the local area. The user may adjust privacy settings to allow or prevent the headset 605 from transmitting information to the mapping server 625. The mapping server 625 determines, based on the received information and/or location information, a location in the virtual model that is associated with the local area of the headset 605. The mapping server 625 determines (e.g., retrieves) one or more acoustic parameters associated with the local area, based in part on the determined location in the virtual model and any acoustic parameters associated with the determined location. The mapping server 625 may transmit the location of the local area and any values of acoustic parameters associated with the local area to the headset 605.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method comprising:
calculating one or more loudspeaker system parameters according to a ratio of loudspeaker displacement to force applied to the loudspeaker and based on current and voltage measured across a loudspeaker, wherein the loudspeaker system parameters include a total mass parameter that relates to a moving mass of the loudspeaker and a radiation mass of a porting of the loudspeaker;
calculating an error as a difference between an expected signal and a measured signal based on the current and the voltage;
updating one or more of the loudspeaker system parameters based on the error; and
delivering audio content via the loudspeaker with the updated one or more loudspeaker system parameters.

2. The computer-implemented method of claim 1, further comprising:
measuring the current and the voltage across the loudspeaker using a drive circuitry configured to drive actuation of the loudspeaker and to sense the current and the voltage.

3. The computer-implemented method of claim 1, further comprising:
determining a loudspeaker health based on the updated one or more loudspeaker system parameters.

4. The computer-implemented method of claim 3, further comprising:
transmitting, to a client device, a notification indicating the loudspeaker health.

5. The computer-implemented method of claim 4, wherein the notification further includes one or more remedial measures based on the loudspeaker health.

6. The computer-implemented method of claim 1, further comprising:
determining that a loudspeaker health issue is present in response to determining that a first loudspeaker system parameter is outside a tolerance range; and
transmitting, to a client device, a notification indicating the loudspeaker health issue.

7. The computer-implemented method of claim 1, wherein updating the one or more loudspeaker system parameters based on the error comprises updating the one or more loudspeaker system parameters with a recursive function.

8. The computer-implemented method of claim 7, wherein the recursive function includes a corrective step based on the calculated error and a convergence hyperparameter.

9. The computer-implemented method of claim 1, wherein calculating the one or more loudspeaker system parameters comprises calculating a subset of the one or more loudspeaker system parameters and fixing a remainder of the one or more loudspeaker system parameters, wherein updating the one or more loudspeaker system parameters comprises updating the subset of loudspeaker system parameters.

10. The computer-implemented method of claim 1, wherein the loudspeaker system parameters further include an electrical resistance of the loudspeaker, an electrical inductance of the loudspeaker, a force factor, a stiffness of the loudspeaker, or some combination thereof, and wherein the one or more loudspeaker system parameters are calculated further according to a voltage equation.

11. An audio system comprising:
a loudspeaker having one or more loudspeaker system parameters, wherein the loudspeaker is configured to generate sound from an electrical signal; and
an audio controller configured to:
calculate one or more loudspeaker system parameters according to a ratio of loudspeaker displacement to force applied to the loudspeaker and based on current and voltage measured across a loudspeaker, wherein the loudspeaker system parameters include a total mass parameter that relates to a moving mass of the loudspeaker and a radiation mass of a porting of the loudspeaker,
calculate an error as a difference between an expected signal and a measured signal based on the current and the voltage,
update one or more of the loudspeaker system parameters based on the error, and
deliver audio content via the loudspeaker with the updated one or more loudspeaker system parameters.

12. The audio system of claim 11, wherein the audio controller is further configured to measure the current and the voltage across the loudspeaker using a drive circuitry configured to drive actuation of the loudspeaker and to sense the current and the voltage.

13. The audio system of claim 11, wherein the audio controller is further configured to determine a loudspeaker health based on the updated one or more loudspeaker system parameters.

14. The audio system of claim 13, wherein the audio controller is further configured to transmitting, to a client device, a notification indicating the loudspeaker health.

15. The audio system of claim 14, wherein the notification further includes one or more remedial measures based on the loudspeaker health.

16. The audio system of claim 11, wherein the audio controller is further configured to:
determine that a loudspeaker health issue is present in response to determining that a first loudspeaker system parameter is outside a tolerance range; and
transmit, to a client device, a notification indicating the loudspeaker health issue.

17. The audio system of claim 11, wherein being configured to update the one or more loudspeaker system parameters based on the error comprises being configured to update the one or more loudspeaker system parameters with a recursive function.

18. The audio system of claim 17, wherein the recursive function includes a corrective step based on the calculated error and a convergence hyperparameter.

19. The audio system of claim 11, wherein being configured to calculate the one or more loudspeaker system parameters comprises being configured to calculate a subset of the one or more loudspeaker system parameters and to fix a remainder of the one or more loudspeaker system parameters, wherein being configured to update the one or more loudspeaker system parameters comprises being configured to update the subset of loudspeaker system parameters.

20. The audio system of claim 11, wherein the loudspeaker system parameters further include an electrical resistance of the loudspeaker, an electrical inductance of the loudspeaker, a force factor, a stiffness of the loudspeaker, or some combination thereof, and wherein the one or more loudspeaker system parameters are calculated further according to a voltage equation.
